(19) United States
(12) Patent Application Publication
(10) Pub. No.: US 2026/0142741 A1
(43) Pub. Date: May 21, 2026

(54) APPARATUS AND METHOD FOR DETECTING AND RESPONDING TO MOBILE COMMUNICATION RADIO FREQUENCY JAMMING ATTACKS IN OPEN RAN ENVIRONMENT

(71) Applicant: Electronics and Telecommunications Research Institute, Daejeon (KR)

(72) Inventors: Hyeok Chan KWON, Daejeon (KR); Byung Ho CHUNG, Daejeon (KR)

(21) Appl. No.: 19/387,383

(22) Filed: Nov. 12, 2025

(30) Foreign Application Priority Data
Nov. 20, 2024 (KR) 10-2024-0165917
Oct. 22, 2025 (KR) 10-2025-0153439

(51) Int. Cl. H04K 3/00

(52) U.S. Cl. CPC H04K 3/22; H04K 3/25; H04K 2203/16

(57) ABSTRACT

The present disclosure provides an apparatus and method for detecting and responding to radio frequency jamming attacks in an Open RAN environment. An O-DU generates physical layer data including SNR, CQI, BLER, or MCS and transmits the data to a Near-RT RIC through an E2 interface. The Near-RT RIC stores the physical layer data in an SDL. An RF jamming detection xApp receives the physical layer data from the SDL to detect radio frequency jamming attacks. The xApp transmits the detected attack information to a network slice management rApp of a Non-RT RIC through an O1 interface to enable dynamic response through network slicing.

### CROSS REFERENCE TO RELATED APPLICATION

This application claims priority to Korean Patent Application No. 10-2024-0165917, filed on November 20, 2024, and Korean Patent Application No. 10-2025-0153439, filed on October 22, 2025, the entire contents of which are hereby incorporated by reference.

### BACKGROUND OF THE INVENTION

### FIELD OF THE INVENTION

The present disclosure relates generally to wireless communication systems, and more particularly, to an apparatus and method for detecting and responding to mobile communication radio frequency jamming attacks in an Open RAN (Open Radio Access Network) environment.

### DESCRIPTION OF THE RELATED ART

5G wireless communication networks provide high bandwidth and low latency, serving as a foundation for various services. However, when wireless interference threats such as RF (Radio Frequency) jamming attacks occur in such environments, they can lead to network performance degradation and service interruptions.

In traditional 5G network structures, detection of Radio Frequency (RF) jamming employed separate spectrum analyzers or analyzed Physical Layer (PHY) data in the core network. However, the conventional structure has the following problems.

Due to limitations of centralized analysis, data analysis is performed in the central core network, resulting in degraded real-time performance and efficiency. Due to lack of flexibility, network components are designed with a closed structure, limiting the application and optimization of new detection algorithms. Due to inefficiency in jamming response, conventional methods simply changed frequencies or adjusted transmission power after detection, which is not effective against sophisticated jamming attacks.

In contrast, in an Open RAN (Open Radio Access Network) environment, network status data of mobile communication base stations is opened, making it possible to detect radio frequency jamming attacks by analyzing network status at the base station level. Additionally, the slicing functionality previously provided by the 5G core can now be provided at the base station level in Open RAN, providing advantages for appropriate responses when radio frequency jamming attacks occur.

Open RAN is an open mobile communication base station that, unlike conventional closed base stations, opens interfaces and data within the base station and enables provision of various additional services by mounting 3rd party applications (xApp, rApp).

Therefore, there is a need for a new method that can effectively detect and respond to radio frequency jamming attacks by utilizing Open RAN's open structure and network slicing technology even in congested wireless communication environments with increasing threats.

### SUMMARY OF THE INVENTION

Based on the above discussion, the present disclosure provides an apparatus and method for accurately detecting radio frequency jamming attacks through real-time data analysis at the base station level in an Open RAN environment.

Additionally, the present disclosure provides an apparatus and method for performing dynamic and flexible responses when jamming attacks occur by utilizing Open RAN's network slicing technology.

Furthermore, the present disclosure provides an apparatus and method for solving the limitations of centralized analysis and lack of flexibility in conventional closed base station structures.

According to various embodiments of the present disclosure, an apparatus for detecting radio frequency jamming attacks in an Open RAN environment comprises a control unit connected to an O-DU (Open RAN Distributed Unit) through an E2 interface and including a Near-RT RIC (Near-Real-Time RAN Intelligent Controller), wherein the O-DU generates physical layer data including at least one of SNR (Signal-to-Noise Ratio), CQI (Channel Quality Indicator), BLER (Block Error Rate), or MCS (Modulation and Coding Scheme) and transmits the physical layer data to the Near-RT RIC through the E2 interface.

According to various embodiments of the present disclosure, a method for detecting and responding to radio frequency jamming attacks in an Open RAN environment comprises: an O-DU generating physical layer data; the O-DU transmitting the physical layer data to a Near-RT RIC through an E2 interface; the Near-RT RIC storing the physical layer data in an SDL (Shared Data Layer); and an RF (Radio Frequency) jamming detection xApp receiving the physical layer data from the SDL to detect radio frequency jamming attacks.

According to various embodiments of the present disclosure, an apparatus for responding to radio frequency jamming attacks in an Open RAN environment comprises a Near-RT RIC connected to a Non-RT RIC (Non-Real-Time RAN Intelligent Controller) through an O1 interface, wherein the Non-RT RIC executes a network slice management rApp that receives jamming attack information, identifies affected network slices, and establishes response policies.

The apparatus and method according to various embodiments of the present disclosure can provide reliable security threat detection capabilities by significantly improving RF jamming detection accuracy compared to conventional 5G networks through RIC-based real-time data analysis.

Additionally, the apparatus and method according to various embodiments of the present disclosure can ensure stable network service continuity even during attack situations by preventing quality degradation of key services and improving user experience through dynamic responses utilizing network slicing.

Effects obtainable from the present disclosure are not limited to the effects mentioned above, and other effects not mentioned will be clearly understood by those having ordinary knowledge in the technical field to which the present disclosure belongs from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates an overall system structure for Open RAN-based radio frequency jamming detection and response according to an embodiment of the present disclosure.

FIG. 2 illustrates a data collection structure and data flow for radio frequency jamming detection according to an embodiment of the present disclosure.

FIG. 3 illustrates a data request and subscription process of an xApp according to an embodiment of the present disclosure.

FIG. 4 illustrates types of data collected and analyzed for radio frequency jamming detection according to an embodiment of the present disclosure.

FIG. 5 illustrates a radio frequency jamming attack response structure through network slicing according to an embodiment of the present disclosure.

FIG. 6 illustrates an overall flowchart of a method for detecting and responding to radio frequency jamming attacks according to an embodiment of the present disclosure.

FIG. 7 illustrates an apparatus configuration diagram according to various embodiments of the present disclosure.

### DETAILED DESCRIPTION OF THE INVENTION

Terms used in the present disclosure are used only to describe specific embodiments and may not be intended to limit the scope of other embodiments. Singular expressions may include plural expressions unless the context clearly indicates otherwise. Technical or scientific terms used herein may have the same meaning as commonly understood by one of ordinary skill in the technical field described in the present disclosure. Among the terms used in the present disclosure, terms defined in general dictionaries may be interpreted as having the same or similar meaning as the meaning in the context of the related art, and unless explicitly defined in the present disclosure, are not interpreted in an ideal or excessively formal sense. In some cases, even terms defined in the present disclosure cannot be interpreted to exclude embodiments of the present disclosure.

Various embodiments of the present disclosure described below illustrate a hardware approach as an example. However, since various embodiments of the present disclosure include technology using both hardware and software, the various embodiments of the present disclosure do not exclude software-based approaches.

Additionally, in the detailed description and claims of the present disclosure, "at least one of A, B, and C" may mean "only A," "only B," "only C," or "any combination of A, B, and C."

Also, "at least one of A, B, or C" or "at least one of A, B, and/or C" may mean "at least one of A, B, and C."

Hereinafter, the present disclosure relates to an apparatus and method for detecting and responding to mobile communication radio frequency jamming attacks in an Open RAN environment in a wireless communication system. Specifically, the present disclosure describes technology for effectively detecting and responding to radio frequency jamming attacks by utilizing Open RAN's open structure and network slicing technology in a wireless communication system.

Terms referring to signals, terms referring to channels, terms referring to control information, terms referring to network entities, and terms referring to components of devices used in the following description are exemplified for convenience of explanation. Therefore, the present disclosure is not limited to the terms described below, and other terms having equivalent technical meanings may be used.

Additionally, although the present disclosure describes various embodiments using terms used in some communication standards (e.g., 3GPP (3rd Generation Partnership Project)), this is merely an example for explanation. Various embodiments of the present disclosure can be easily modified and applied to other communication systems.

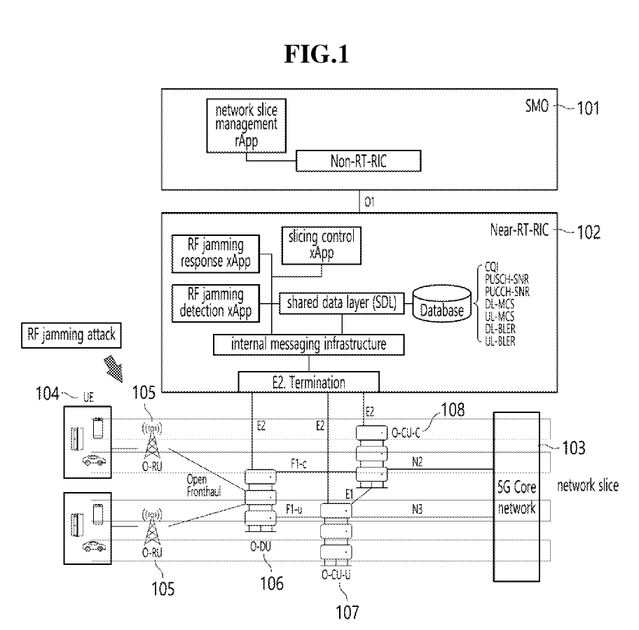

FIG. 1 illustrates an overall system structure for Open RAN-based radio frequency jamming detection and response according to an embodiment of the present disclosure. FIG. 1 is intended to show overall how jamming detection and response are achieved through Open RAN's open structure, unlike conventional closed base station structures.

Referring to FIG. 1, the system includes a UE (User Equipment) 104, an O-RU (Open RAN Radio Unit) 105, an O-DU (Open RAN Distributed Unit) 106, an O-CU-U (Open RAN Centralized Unit-User plane) 107, an O-CU-C (Open RAN Centralized Unit-Control plane) 108, a Near-RT RIC (Near-Real-Time RAN Intelligent Controller) 102, a Non-RT RIC (Non-Real-Time RAN Intelligent Controller) inside an SMO (Service Management and Orchestration) 101, and a 5G Core Network 103.

The UE 104 is a user terminal that receives communication services through the Open RAN network and is a component directly affected when jamming attacks occur. The O-RU 105 is a network component responsible for transmission and reception of radio signals and propagation processing, consisting of the lower physical layer of the base station and the RF

(Radio Frequency) interface part, performing direct wireless communication with the UE 104.

The O-DU 106 is a component that performs functions of the upper physical layer, MAC (Media Access Control), and RLC (Radio Link Control) layers, playing the most important role in the present disclosure. The O-DU 106 generates physical layer data, which is core data for jamming detection, such as SNR (Signal-to-Noise Ratio), CQI (Channel Quality Indicator), BLER (Block Error Rate), and MCS (Modulation and Coding Scheme), and transmits it to the Near-RT RIC 102 through the E2 interface.

The O-CU-U 107 and O-CU-C 108 are centralized units responsible for the user plane and control plane, respectively, performing upper protocol processing and providing connections with the core network and advanced network functions. When responding to jamming, they physically execute actual network slice adjustments by receiving slicing control commands.

The Near-RT RIC 102 is a core component of the present disclosure, performing real-time or near-real-time control and management. Inside the Near-RT RIC 102, an RF jamming detection xApp and a slicing control xApp are included, and data is managed through the SDL (Shared Data Layer) and internal messaging infrastructure. It receives data from the O-DU 106 and O-CU through the E2 interface and communicates with the Non-RT RIC through the O1 interface.

The SMO 101 is a top-level management platform responsible for service management and orchestration, with the Non-RT RIC included inside it. The Non-RT RIC is responsible for long-term network optimization and policy management, establishing response policies for jamming attacks through the network slice management rApp.

The 5G Core Network 103 is the existing 5G core network that provides network slicing functionality and supports overall network services in conjunction with Open RAN.

The key point shown in FIG. 1 is that, unlike the conventional centralized analysis method, Open RAN's distributed structure enables real-time jamming detection at the base station level and immediate and flexible responses using network slicing.

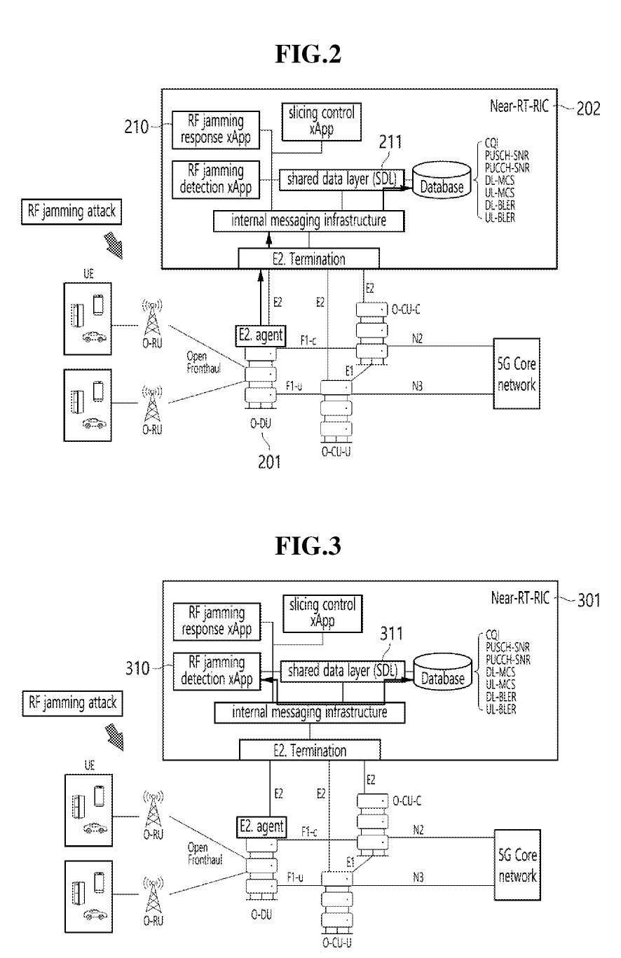

FIG. 2 illustrates a data collection structure and data flow for radio frequency jamming detection according to an embodiment of the present disclosure. FIG. 2 specifically shows how physical layer data generated in the O-DU (Open RAN Distributed Unit) 201 is transferred to the Near-RT RIC (Near-Real-Time RAN Intelligent Controller) 202 and utilized for jamming detection.

Referring to FIG. 2, the O-DU 201 generates physical layer data such as SNR (Signal-to-Noise Ratio), CQI (Channel Quality Indicator), BLER (Block Error Rate), and MCS (Modulation and Coding Scheme). These data show specific patterns when jamming attacks occur, with SNR, CQI, and MCS values decreasing and BLER values increasing.

The generated physical layer data is transmitted to the E2 Termination of the Near-RT RIC 202 through the E2 interface. The data flow indicated by arrows represents this real-time data transmission path. The data passes through the internal messaging infrastructure and is stored in the SDL (Shared Data Layer) 211.

The RF jamming detection xApp 210 accesses the physical layer data stored in the SDL 211 to detect jamming attacks. In this process, the xApp 210 can directly request and receive data or receive notifications through a subscribe method for specific threshold changes.

The key point shown in FIG. 2 is that, unlike conventional centralized data analysis, in the Open RAN environment, physical layer data can be collected and analyzed in real-time at the base station level, greatly improving the accuracy and speed of jamming detection.

FIG. 3 illustrates a data request and subscription process of an xApp according to an embodiment of the present disclosure. FIG. 3 specifically shows how the RF jamming detection xApp 310 acquires and processes analytical data inside the Near-RT RIC 301.

Referring to FIG. 3, the RF jamming detection xApp 310 acquires analytical data necessary for jamming detection from the SDL (Shared Data Layer) 311. This process can be performed in two ways.

The first method is a request method, where the RF jamming detection xApp 310 directly requests necessary data from the internal messaging infrastructure. The internal messaging infrastructure calls the SDL API to retrieve the requested data from the database and provides it to the xApp 310.

The second method is a subscribe method, where the RF jamming detection xApp 310 sets up subscriptions in advance for changes to specific data. For example, it can be configured to automatically receive notifications when network metrics such as SNR (Signal-to-Noise Ratio) and CQI (Channel Quality Indicator) exceed specific thresholds or change. This enables real-time monitoring of network status changes and rapid detection of jamming attacks.

The key point shown in FIG. 3 is that by providing a flexible mechanism for xApp to access data in the Open RAN environment, real-time monitoring and immediate response are possible. This structure enables implementation of a jamming detection system that is much more efficient and scalable compared to conventional closed systems.

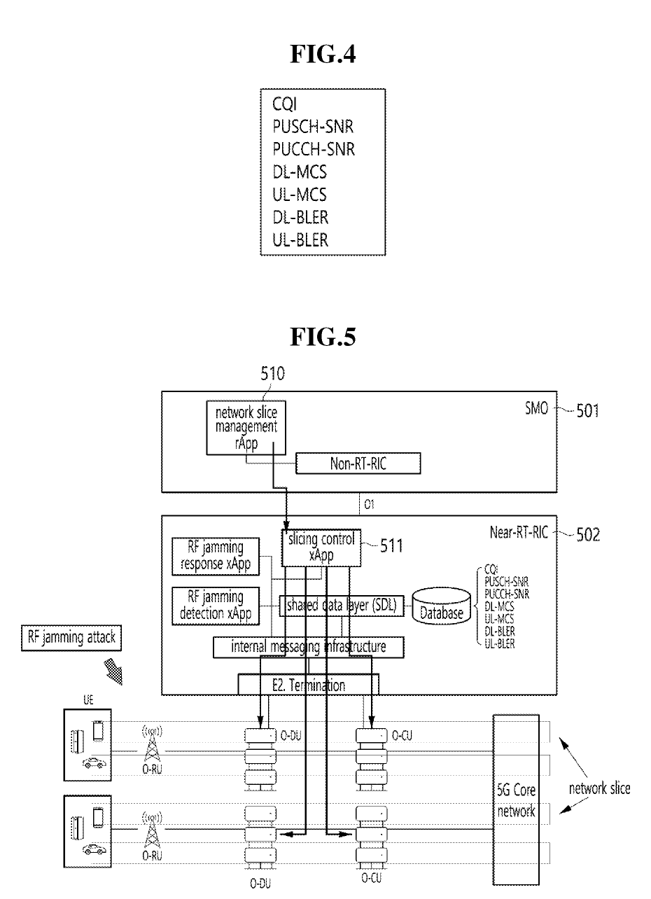

According to one embodiment of the present disclosure, the SDL (Shared Data Layer) 311 described in FIG. 3 may include a graph database structure for comprehensively managing network-wide topology and jamming attack situations, beyond simply storing physical layer data. This database structure systematically organizes information collected in the data collection structure of FIG. 2 and provides a decision-making basis for network slicing-based responses to be described in FIG. 5.

The graph database of the SDL defines four types of node types to represent network situations. Base station nodes represent Open RAN components such as O-RU 105, O-DU 106, O-CU-U 107, and O-CU-C 108 shown in FIG. 1, with each node including the current state, processing capacity, and load information of the corresponding component as attributes. User nodes represent UEs 104 of FIG. 1 individually or in groups, tracking each user's quality of service requirements and jamming impact. Slice nodes represent network slices to be described in detail in FIG. 5, managing the type, priority, and allocated resources of each slice. Threat nodes represent jamming attack sources or suspicious areas detected by the RF jamming detection xApp, containing attack intensity and impact range information.

These nodes are connected by seven types of link types. Control links represent control relationships through the E2 interface and O1 interface of FIG. 1. Data links represent paths where actual user traffic flows. Service links show which network slice each UE is mapped to. Interference links indicate which network elements are affected by jamming sources. Response links represent paths where slicing control commands to be described in FIG. 5 are applied. Dependency links represent functional dependencies between components. Backup links predefine alternative paths or backup slice connections that can be utilized when responding to jamming.

Through this graph database structure, the RF jamming detection xApp 310 can analyze changes in physical layer data to be described in FIG. 4 in the context of network topology, and can identify the propagation pattern and impact range of jamming attacks in real-time.

Additionally, the network slice management rApp can establish optimal slicing response strategies to be described in FIG. 5 based on this information.

FIG. 4 illustrates types of data collected and analyzed for radio frequency jamming detection according to an embodiment of the present disclosure. FIG. 4 shows the core physical layer data generated in the O-DU (Open RAN Distributed Unit) and utilized for jamming detection in an organized manner.

Referring to FIG. 4, the data analyzed for jamming detection is as follows. CQI (Channel Quality Indicator) is an indicator representing wireless link quality, and its value decreases as the signal-to-interference ratio becomes lower when jamming attacks occur. PUSCH-SNR (Physical Uplink Shared Channel Signal-to-Noise Ratio) and PUCCH-SNR (Physical Uplink Control Channel Signal-to-Noise Ratio) are signal-to-noise ratios for data channels and control channels, respectively, and their values drop sharply due to increased noise during jamming attacks.

DL-MCS (Downlink Modulation and Coding Scheme) and UL-MCS (Uplink Modulation and Coding Scheme) refer to the modulation and coding schemes used in downlink and uplink, respectively. When link quality degrades due to jamming attacks, the base station attempts to maintain data transmission stability by selecting lower modulation and coding schemes, resulting in decreased MCS values.

DL-BLER (Downlink Block Error Rate) and UL-BLER (Uplink Block Error Rate) represent the rate of errors occurring among data blocks transmitted in downlink and uplink, respectively. When signals are distorted or lost due to jamming attacks, many errors occur during data block transmission, resulting in increased BLER values.

Since these data show different patterns in normal network operation situations and jamming attack situations, effective jamming detection is possible by the RF jamming detection xApp analyzing changes in these data or learning through artificial intelligence machine learning.

FIG. 5 illustrates a radio frequency jamming attack response structure through network slicing according to an embodiment of the present disclosure. FIG. 5 shows how systematic and effective responses are achieved using Open RAN's network slicing technology after jamming attacks are detected.

Referring to FIG. 5, the jamming response process proceeds as follows. First, jamming attack information detected by the RF jamming detection xApp is transmitted to the network slice management rApp 510 inside the SMO (Service Management and Orchestration) 501 through the O1 interface. The data flow indicated by arrows represents this information delivery path.

The network slice management rApp 510 runs within the Non-RT RIC (Non-Real-Time RAN Intelligent Controller), analyzes the received jamming attack information, and identifies affected network slices. In this process, the rApp 510 comprehensively considers jamming attack characteristics, impact range, service priorities, etc., to establish appropriate response policies.

The established response policies are transmitted to the slicing control xApp 511 of the Near-RT RIC (Near-Real-Time RAN Intelligent Controller) 502 through the O1 interface. The slicing control xApp 511 converts the received policies into specific slicing control commands and transmits them to the O-CU (Open RAN Centralized Unit) and O-DU (Open RAN Distributed Unit) through the E2 interface.

Specific jamming response methods include: adjusting slice priorities to reduce resources of slices where jamming occurs and reallocate resources to slices requiring bypass; slice isolation methods that physically and logically isolate slices where attacks occurred; alternative path activation methods that bypass traffic in attack areas to other slices in nearby areas; frequency reallocation methods that switch resources to bandwidths where no attacks occurred when frequency jamming is detected; and service migration methods that change traffic paths to slices not affected by jamming for critical services. For example, measures such as isolating slices with SNR degradation rates above thresholds and reallocating resources to adjacent slices when BLER exceeds certain levels are possible.

The key point shown in FIG. 5 is that dynamic and intelligent responses to jamming attacks are possible through Open RAN's hierarchical structure and network slicing technology. This provides an advanced response mechanism that goes beyond conventional simple frequency change or power adjustment methods.

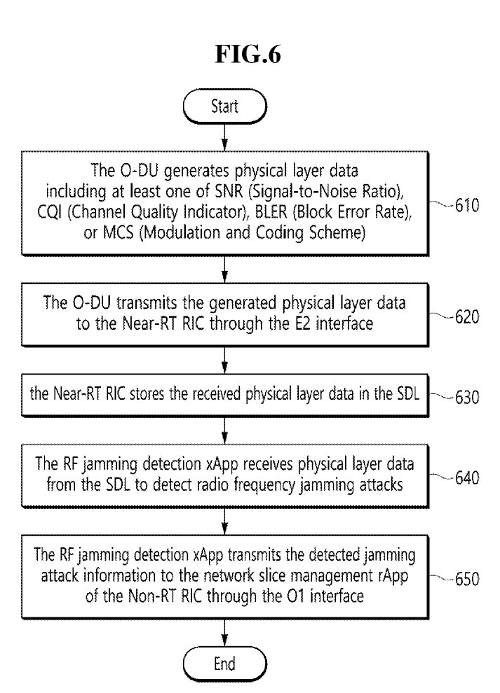

FIG. 6 illustrates an overall flowchart of a method for detecting and responding to radio frequency jamming attacks according to an embodiment of the present disclosure. FIG. 6 clearly presents the entire process from jamming detection to response in the Open RAN environment.

Referring to FIG. 6, the method proceeds with the following steps. In step 610, the O-DU (Open RAN Distributed Unit) generates physical layer data including at least one of SNR (Signal-to-Noise Ratio), CQI (Channel Quality Indicator), BLER (Block Error Rate), or MCS

(Modulation and Coding Scheme). In one embodiment, the physical layer data may further include at least one of PUSCH-SNR (Physical Uplink Shared Channel SNR), PUCCH-SNR (Physical Uplink Control Channel SNR), DL (Downlink) data, or UL (Uplink) data.

In step 620, the O-DU transmits the generated physical layer data to the Near-RT RIC (Near-Real-Time RAN Intelligent Controller) through the E2 interface. This is a process of performing real-time data transmission by utilizing Open RAN's open structure.

In step 630, the Near-RT RIC stores the received physical layer data in the SDL (Shared Data Layer). In this process, data is processed through the internal messaging infrastructure and systematically managed.

In step 640, the RF (Radio Frequency) jamming detection xApp receives physical layer data from the SDL to detect radio frequency jamming attacks. In one embodiment, jamming detection may be performed by subscribing to changes in physical layer data and receiving notifications when thresholds are exceeded. In another embodiment, the RF jamming detection xApp may detect radio frequency jamming attacks based on decreases in SNR, CQI, or MCS values or increases in BLER values. In yet another embodiment, radio frequency jamming attacks may be detected by learning change patterns of physical layer data through artificial intelligence machine learning.

In step 650, the RF jamming detection xApp transmits the detected jamming attack information to the network slice management rApp of the Non-RT RIC (Non-Real-Time RAN Intelligent Controller) through the O1 interface.

In one embodiment, the network slice management rApp may identify slices affected by the jamming attack, establish response policies, and transmit the response policies to the slicing control xApp of the Near-RT RIC through the O1 interface. Subsequently, the slicing control xApp may analyze the response policies to generate slicing control commands and transmit the slicing control commands to the O-CU (Open RAN Centralized Unit) and O-DU through the E2 interface.

In another embodiment, the slicing control commands may include at least one of slice priority readjustment, slice isolation, alternative slice activation, frequency reallocation, or service migration. Additionally, this method may be performed in a 5G network environment, and the Open RAN may be configured with O-RU, O-DU, or O-CU.

The key point shown in FIG. 6 is that jamming can be detected in real-time at the base station level through Open RAN's distributed structure, and this can be delivered to upper management systems for systematic responses. This method provides much faster and more efficient jamming detection and response compared to conventional centralized analysis methods.

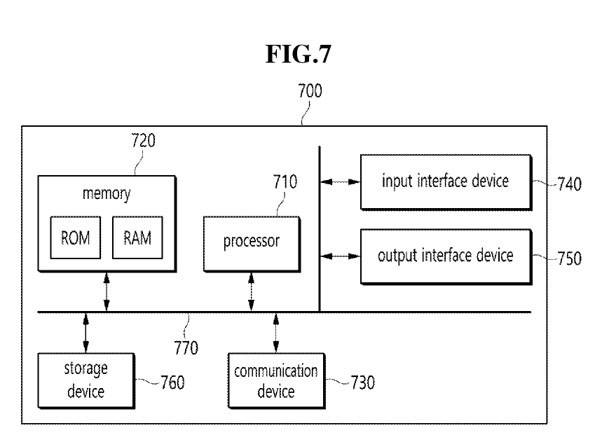

FIG. 7 illustrates an apparatus configuration diagram according to an embodiment of the present disclosure.

Referring to FIG. 7, an Open RAN-based jamming detection and response apparatus 700 may include at least one processor 710, a memory 720, and a communication device 730 connected to a network to perform communication. Additionally, the jamming detection and response apparatus 700 may further include an input interface device 740, an output interface device 750, a storage device 760, and the like. Each component included in the jamming detection and response apparatus 700 is connected by a bus 770 and can communicate with each other.

However, each component included in the jamming detection and response apparatus 700 may be connected through individual interfaces or individual buses centered on the processor 710 rather than the common bus 770. For example, the processor 710 may be connected to at least one of the memory 720, communication device 730, input interface device 740, output interface device 750, and storage device 760 through dedicated interfaces.

The communication device 730 is implemented as a transceiver responsible for data transmission and reception through the E2 interface and O1 interface, and performs communication with the O-CU (Open RAN Centralized Unit) and O-DU (Open RAN Distributed Unit). The processor 710 is configured to generate and process physical layer data including at least one of SNR (Signal-to-Noise Ratio), CQI (Channel Quality Indicator), BLER (Block Error Rate), or MCS (Modulation and Coding Scheme).

The storage device 760 implements SDL (Shared Data Layer) functionality to store and manage physical layer data and performs data processing through the internal messaging infrastructure. The processor 710 is configured to execute an RF jamming detection xApp to detect radio frequency jamming attacks based on stored data.

The processor 710 performs functions to request and receive physical layer data from the

SDL or subscribe to changes in physical layer data to receive notifications when thresholds are exceeded. Additionally, the processor 710 is configured to detect jamming attacks based on decreases in SNR, CQI, or MCS values or increases in BLER values, or to detect jamming attacks by learning change patterns of physical layer data through artificial intelligence machine learning.

The processor 710 executes a slicing control xApp to generate slicing control commands, and these commands include at least one of slice priority readjustment, slice isolation, alternative slice activation, frequency reallocation, or service migration. Additionally, the processor 710 is configured to execute a network slice management rApp to identify slices affected by jamming attacks and establish response policies.

The apparatus 700 may include SMO (Service Management and Orchestration) functionality to integrally manage operations of the Non-RT RIC (Non-Real-Time RAN Intelligent Controller) and Near-RT RIC (Near-Real-Time RAN Intelligent Controller). Additionally, the apparatus 700 is configured to execute physical control over network slices according to slicing control commands.

The processor 710 may mean a central processing unit (CPU), graphics processing unit (GPU), or dedicated processor on which methods according to embodiments of the present disclosure are performed. Each of the memory 720 and storage device 760 may consist of at least one of volatile storage media and non-volatile storage media. For example, the memory 720 may consist of at least one of read only memory (ROM) and random access memory (RAM).

Methods according to embodiments described in the claims or specification of the present disclosure may be implemented in the form of hardware, software, or a combination of hardware and software.

When implemented as software, a computer-readable storage medium storing one or more programs (software modules) may be provided. One or more programs stored in the computer-readable storage medium are configured for execution by one or more processors within an electronic device. One or more programs include instructions that cause the electronic device to execute methods according to embodiments described in the claims or specification of the present disclosure.

Such programs (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage devices, or magnetic cassettes. Alternatively, they may be stored in memory consisting of some or all combinations thereof. Additionally, each constituent memory may be included in plural.

Additionally, programs may be stored in attachable storage devices that can be accessed through communication networks such as the Internet, Intranet, local area network (LAN), wide area network (WAN), or storage area network (SAN), or communication networks consisting of combinations thereof. Such storage devices may connect to devices performing embodiments of the present disclosure through external ports. Additionally, separate storage devices on communication networks may connect to devices performing embodiments of the present disclosure.

In the specific embodiments of the present disclosure described above, components included in the disclosure are expressed in singular or plural forms according to the specific embodiments presented. However, singular or plural expressions are selected appropriately for situations presented for convenience of explanation, and the present disclosure is not limited to singular or plural components; components expressed in plural may be configured as singular, or components expressed in singular may be configured as plural.

Meanwhile, although specific embodiments have been described in the detailed description of the present disclosure, various modifications are possible without departing from the scope of the present disclosure. Therefore, the scope of the present disclosure should not be limited to the described embodiments but should be defined by the scope of claims described below as well as equivalents to the scope of claims.

What is claimed is:

1. An apparatus for detecting radio frequency jamming attacks in an Open Radio Access Network (Open RAN) environment, the apparatus comprising:
an Open RAN Distributed Unit (O-DU); and
a control unit connected to the O-DU through an E2 interface and including a Near-Real-Time RAN Intelligent Controller (Near-RT RIC),
wherein the O-DU generates physical layer data including at least one of Signal-to-Noise Ratio (SNR), Channel Quality Indicator (CQI), Block Error Rate (BLER), or Modulation and Coding Scheme (MCS), and transmits the physical layer data to the Near-RT RIC through the E2 interface, and
wherein the Near-RT RIC is configured to store the physical layer data in a Shared Data Layer (SDL) through an internal messaging infrastructure and execute an RF jamming detection xApp configured to detect radio frequency jamming attacks based on data stored in the SDL.

2. The apparatus of claim 1, wherein the RF jamming detection xApp is configured to request and receive the physical layer data from the SDL or subscribe to changes in the physical layer data to receive notifications when thresholds are exceeded.

3. The apparatus of claim 1, wherein the physical layer data further includes at least one of Physical Uplink Shared Channel SNR (PUSCH-SNR), Physical Uplink Control Channel SNR (PUCCH-SNR), Downlink (DL) data, or Uplink (UL) data.

4. The apparatus of claim 1, wherein the RF jamming detection xApp is configured to detect radio frequency jamming attacks based on decreases in the SNR, CQI, or MCS values or increases in the BLER value.

5. The apparatus of claim 1, wherein the RF jamming detection xApp is configured to detect radio frequency jamming attacks by learning change patterns of the physical layer data through artificial intelligence machine learning.

6. A method for detecting and responding to radio frequency jamming attacks in an Open Radio Access Network (Open RAN) environment, the method comprising:
generating, by an Open RAN Distributed Unit (O-DU), physical layer data including at least one of Signal-to-Noise Ratio (SNR), Channel Quality Indicator (CQI), Block Error Rate (BLER), or Modulation and Coding Scheme (MCS);
transmitting, by the O-DU, the physical layer data to a Near-Real-Time RAN Intelligent Controller (Near-RT RIC) through an E2 interface;
storing, by the Near-RT RIC, the physical layer data in a Shared Data Layer (SDL);
receiving, by a Radio Frequency (RF) jamming detection xApp, the physical layer data from the SDL to detect radio frequency jamming attacks; and
transmitting, by the RF jamming detection xApp, detected jamming attack information to a network slice management rApp of a Non-Real-Time RAN Intelligent Controller (Non-RT RIC) through an O1 interface.

7. The method of claim 6, further comprising:
identifying, by the network slice management rApp, slices affected by the jamming attack and establishing response policies; and
transmitting, by the network slice management rApp, the response policies to a slicing control xApp of the Near-RT RIC through the O1 interface.

8. The method of claim 7, further comprising:
analyzing, by the slicing control xApp, the response policies to generate slicing control commands; and
transmitting, by the slicing control xApp, the slicing control commands to an Open RAN Centralized Unit (O-CU) and the O-DU through the E2 interface.

9. The method of claim 8, wherein the slicing control commands include at least one of slice priority readjustment, slice isolation, alternative slice activation, frequency reallocation, or service migration.

10. The method of claim 6, wherein detecting radio frequency jamming attacks comprises subscribing to changes in the physical layer data to receive notifications when thresholds are exceeded.

11. An apparatus for responding to radio frequency jamming attacks in an Open Radio Access Network (Open RAN) environment, the apparatus comprising:
a Non-Real-Time RAN Intelligent Controller (Non-RT RIC); and
a Near-Real-Time RAN Intelligent Controller (Near-RT RIC) connected to the Non-RT RIC through an O1 interface,
wherein the Non-RT RIC executes a network slice management rApp configured to receive jamming attack information, identify affected network slices, and establish response policies, and
wherein the Near-RT RIC executes a slicing control xApp configured to receive the response policies, generate slicing control commands, and transmit the slicing control commands to an Open RAN Centralized Unit (O-CU) and an Open RAN Distributed Unit (O-DU) through an E2 interface.

12. The apparatus of claim 11, wherein the network slice management rApp is configured to reduce resources by lowering priority of slices where jamming occurs and reallocate resources to slices requiring bypass.

13. The apparatus of claim 11, wherein the slicing control xApp is configured to physically and logically isolate slices where attacks occurred and transition them to separate management states.

14. The apparatus of claim 11, wherein the slicing control xApp is configured to perform alternative path activation to bypass traffic in areas where attacks occurred to other slices in nearby areas.

15. The apparatus of claim 11, wherein the slicing control xApp is configured to perform frequency reallocation to switch resources of slices where attacks occurred to bandwidths where no attacks occurred when frequency jamming is detected.

16. The apparatus of claim 11, wherein the network slice management rApp is configured to perform service migration to change traffic paths to slices not affected by jamming for critical services.

17. The apparatus of claim 11, wherein the apparatus further comprises Service Management and Orchestration (SMO), and wherein the SMO is configured to integrally manage operations of the Non-RT RIC and the Near-RT RIC.
